(19) United States
(12) Patent Application Publication
(10) Pub. No.: US 2002/0025791 A1
(43) Pub. Date: Feb. 28, 2002

(54) Handheld two-way radio with digital selective calling

(76) Inventors: John W. Englert, Carmel, IN (US); Stephen J. Hoffman, Carmel, IN (US)

Correspondence Address: Woodard, Emhardt, Naughton, Moriarty and McNett, Bank One Center/Tower, 111 Monument Circle, Suite 3700, Indianapolis, IN, 46204-5137, US

(21) Appl. No.: 09/812,793

(22) Filed: Mar. 20, 2001

Related U.S. Application Data
(60) Provisional application No. 60/190,846, filed on Mar. 20, 2000.

(51) Int. Cl. H04B 1/26

(52) U.S. Cl. 455/196.1; 455/140

(57) ABSTRACT

A preferred embodiment of the present invention generally comprises a hand-held two-way radio employing digital selective calling. The hand-held two-way radio further comprises a VCO operative to modulate the radio signal frequencies of a guard channel such that the guard channel can be changed by changing the output of the VCO. In addition, the present invention comprises a hand-held two-way radio comprising circuitry operative to function according to the digital selective calling international standards, and a VCO operative to modulate the radio signal frequencies of a guard channel such that the guard channel can be changed by changing the output of the VCO. A fourth embodiment of the present invention comprises a hand-held two-way radio comprising circuitry operative to send and receive GPS data, and a VCO operative to modulate the radio signal frequencies of a guard channel such that the guard channel can be changed by changing the output of the VCO.

### CROSS-REFERENCE TO RELATED APPLICATIONS

The present application claims priority under 35 U.S.C. §120 from U.S. Provisional Application Ser. No. 60/190,846, filed Mar. 20, 2000.

### TECHNICAL FIELD OF THE INVENTION

The present invention generally relates to electronic communication devices and, more particularly, to a handheld two-way radio with digital selective calling.

### BACKGROUND OF THE INVENTION

Digital selective calling was conceived by an international committee in the early 1970s. Its purpose was to expedite the handling of traffic in the maritime service by facilitating more efficient calling between ships and from ship to shore, and to provide a more automated distress and safety system. The international committee, known as the CCIR, comprised representatives from all countries with salt-water coastlines, both from the private and public sectors, including the FCC from the United States.

A key factor in the acceptance of the DSC protocol was the safety of life at sea (SOLAC) treaty of 1974 (amended in 1988), requiring the use of DSC for distress alerting and safety calling. Current international treaties require a limited compliance with this treaty starting in 1992. Since that time, certain types of vessels have been required to have DSC equipment. Recently, many nations have been expediting the implementation of DSC systems in the VHF arena in hopes of relieving some of the congestion on the voice distress and calling channel (channel 16). DSC helps solve this problem as it uses channel 70 for its routine calling channel.

In the DSC system, each radio is programmed with a unique identification number. The radios are carried by vessels, marinas, bridge tenders, coast stations, etc. DSC ship station identification numbers are issued by appropriate communications authorities in each country, such as the FCC (United States) and the DOC (Canada). DSC ship station identification numbers are similar to telephone in that they are unique to each station. Each DSC radio constantly monitors the calling channel (channel 70) looking for a broadcast of its ship station identification number. Therefore, in order to call another DSC radio, the calling radio will broadcast the ship station identification number for the receiving DSC radio, as well as the identity of a separate working channel selected by the caller. The receiving DSC radio, monitoring calling channel 70, will see that it is being called by another radio, and will switch its receiver over to a working channel broadcast with the ship station identification number. The two radios can then communicate with one another on the selected working channel, while continuing to monitor calling channel 70 in case a call is received from another radio.

It can thus be seen that the use of DSC radio completely avoids congestion on channel 16 both during the initial contact and during the subsequent conversation. If an operator is not available to answer a call placed to a DSC radio, the radio will typically log the call in an internal directory so that the call can be returned when the operator is able to do so.

DSC radios have the ability to be connected to a navigation receiver, such as a LORAN-C or GPS receiver, such that the radio will be able to automatically give the radio's position to another vessel with a simple digital call. Alternatively, another DSC radio can request your position from your DSC radio. This makes DSC very useful for vessels locating one another and is particularly useful for fleet operators tracking several vessels.

In the event of an emergency on a vessel, the DSC operator can press one key to broadcast an emergency distress message (on channel 16) using the DSC system. This message will be received by all vessels equipped with DSC equipment and will sound alarms on each one. If the DSC radio is connected to a navigation receiver, the vessel's position will also be broadcast, making it much easier for others to come to aid.

DSC has therefore proved to be a valuable resource in maritime communications. However, an analogous system has never been implemented for land based communications, particularly for mobile (handheld) applications. The present invention is directed toward meeting this need.

### SUMMARY OF THE INVENTION

A first embodiment of the present invention comprises a hand-held two-way radio employing digital selective calling.

A second embodiment of the present invention comprises a VCO operative to modulate the radio signal frequencies of a guard channel such that the guard channel can be changed by changing the output of the VCO.

A third embodiment of the present invention comprises a hand-held two-way radio comprising circuitry operative to function according to the digital selective calling international standards, and a VCO operative to modulate the radio signal frequencies of a guard channel such that the guard channel can be changed by changing the output of the

A fourth embodiment of the present invention comprises a hand-held two-way radio comprising circuitry operative to send and receive GPS data, and a VCO operative to modulate the radio signal frequencies of a guard channel such that the guard channel can be changed by changing the output of the VCO.

### BRIEF DESCRIPTION OF THE DRAWINGS

FIG. 1 is a schematic block diagram of a prior art super heterodyne radio receiver employing selective calling.

FIG. 2 is a schematic block diagram of a first embodiment super heterodyne receiver of the present invention employing digital selective calling.

FIG. 3 is a graph of channel frequency versus attenuation for a prior art bandpass filter.

FIG. 4 is an electrical schematic diagram for a preferred embodiment front end of the present invention.

FIGS. 5A-C are graphs of channel frequency versus attenuation illustrating the operation of adjustable bandpass filter of the present invention.

FIG. 6 is an electrical schematic diagram of the IF section of a preferred embodiment of the present invention.

FIG. 7 is a schematic block diagram of a main RF section of the preferred embodiment of the present invention.

FIG. 8 is an electrical schematic diagram of a main RF section of the preferred embodiment of the present invention.

FIG. 9 is an electrical schematic diagram of the VCO 40, 46 of a preferred embodiment of the present invention.

FIG. 10 is a schematic block diagram of an audio module of the preferred embodiment radio of the present invention, illustrating the audio processing circuitry and data modems.

FIG. 11 is an electrical schematic diagram of an audio module of the preferred embodiment radio of the present invention, illustrating the audio processing circuitry and data modems.

FIG. 12 is an electrical schematic diagram of the central processing unit (CPU) and interface for controlling a preferred embodiment radio of the present invention.

FIG. 13 is an electrical schematic diagram of a keypad for use in the preferred embodiment radio of the present invention.

FIG. 14 is an electrical schematic diagram of the top panel connections for a preferred embodiment radio of the present invention.

FIG. 15 is an electrical schematic diagram of the push-to-talk (PTT) switches for use in a preferred embodiment radio of the present invention.

FIG. 16 is an electrical schematic diagram of a flex circuit for use with a liquid crystal display (LCD) of the preferred embodiment radio of the present invention.

FIG. 17 is an electrical schematic diagram of a flex circuit for use with the top panel of a preferred embodiment radio of the present invention.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

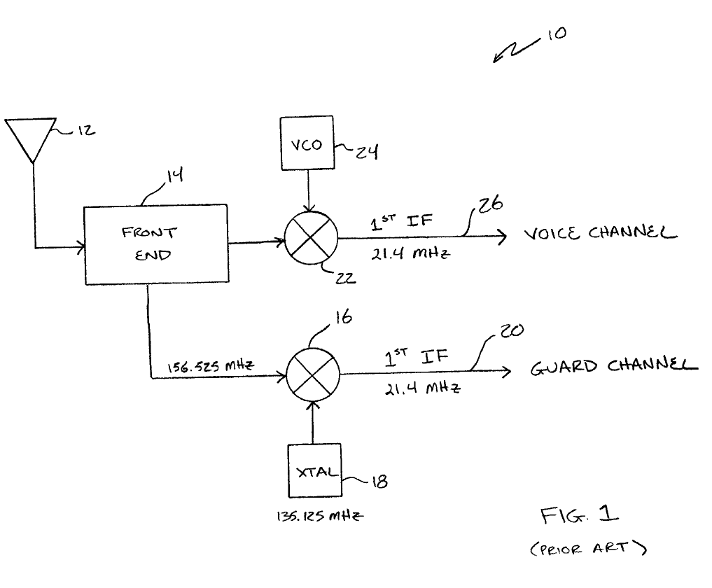

With reference to FIG. 1, there is illustrated a schematic block diagram of a prior art super heterodyne radio receiver employing digital selective calling, indicated generally at 10. The radio 10 includes an antenna 12 capable of coupling electromagnetic radiation in the frequency band of interest and applying this signal to a front end 14. The front end 14 provides standard radio processing functions as known in the art, such as filtering of the signal from the antenna 12 to a particular band of interest. The signal from the front end 14 is applied to a mixer 16, which has a secondary input provided from a crystal 18. The output of the mixer 16 is a first intermediate frequency (IF) signal 20 which is applied to the guard channel processing circuitry of the radio.

Because the guard channel for all prior art digital selective calling radios is channel 70 (156.525 MHz), and the crystal 18 vibrates at a fixed frequency of 135.125 MHz, the first IF signal 20 will always be at exactly 21.4 MHz. Since it is known that the first IF signal 20 will always be 21.4 MHz, the processing circuitry to which the signal 20 is applied can be designed to be optimized for processing at this frequency.

The signal from the front end 14 is additionally applied to a second mixer 22. A second input to the mixer 22 is applied by a voltage controlled oscillator (VCO) 24 because the signals in the front end can be anywhere within a predefined frequency range, a particular frequency (i.e. channel) may be selected by controlling the VCO 24 to emit a frequency that, when combined with the frequency of interest in the mixer 22, produces a first IF signal of 21.4 MHz upon the signal line 26. The signal upon the line 26 is applied to the voice channel processing circuitry, which preferably includes a narrow band pass filter centered on 21.4 MHz. In this way, any channel within the frequency range covered by the front end 14 may be precisely selected by controlling the frequency output of the VCO 24.

The digital selective calling radio 10 of FIG. 1 is useful in marine applications where all radios in use utilize a fixed guard channel 70. If a different guard channel were selected, the crystal 18 would have to be physically removed from the radio 10 and replaced with a crystal that vibrated at the appropriate frequency which would produce a first IF signal 20 of 21.4 MHz for the new guard channel of interest. This presents a problem in land-based used for DSC radios. Different organizations with wish to use land-based DSC radios (such as fire departments, lifeguard departments, etc.) can potentially be located in close physical proximity to one another. Because these organizations would not necessarily be involved with one another's operations, they could potentially desire to have different guard channels, such that, for example, the fire chief could call all of the fire department radios upon their assigned guard channel without disturbing the radios of the lifeguards. For this reason, land-based DSC radios will preferably have guard channels which differ from location to location. If the prior art design of radio 10 is utilized, then a different radio needs to be manufactured for each different location.

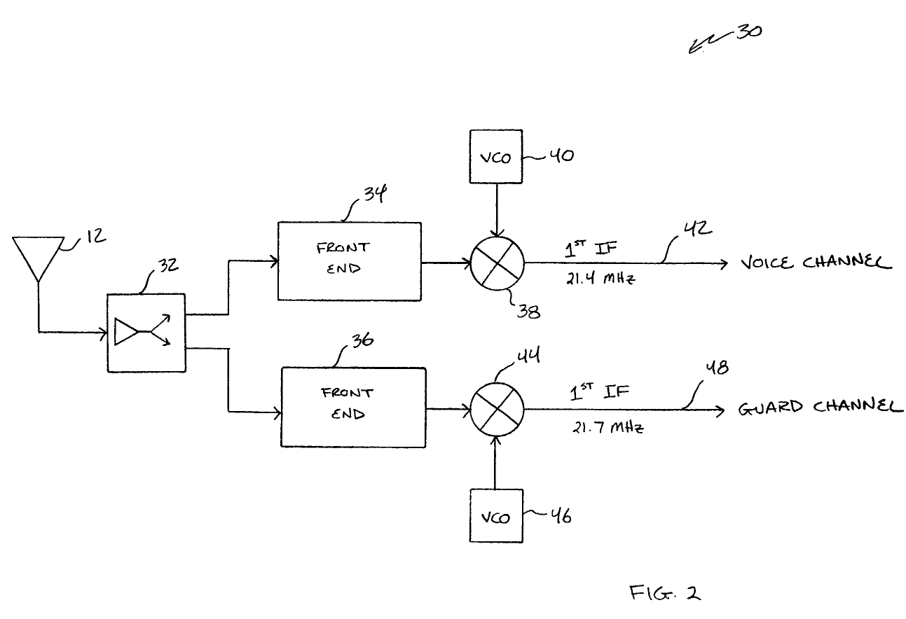

In order to solve this problem, the present invention utilizes a first embodiment super heterodyne receiver architecture as illustrated in FIG. 2 and indicated generally at 30. The radio 30 also uses an antenna 12 which couples electromagnetic signals and applies these to a splitter 32. The splitter 32 applies the signal from antenna 12 (at a signal power decreased by 3 dB) to front ends 34 and 36, which contain processing circuitry as is known in the art. The signal from the front end 34 is applied to a mixer 38. A signal from a voltage controlled oscillator (VCO) 40 is also applied to the mixer 38. In this way, a particular frequency of interest may be selected from the signal supplied by the front end 34 by selecting a VCO 40 frequency which, when mixed with the front end signal of interest in the mixer 38, produces a first IF signal of 21.4 MHz on the line 42. This signal is applied to the voice channel processing circuitry, which includes a narrow band pass filter to select the 21.4 MHz signal of interest.

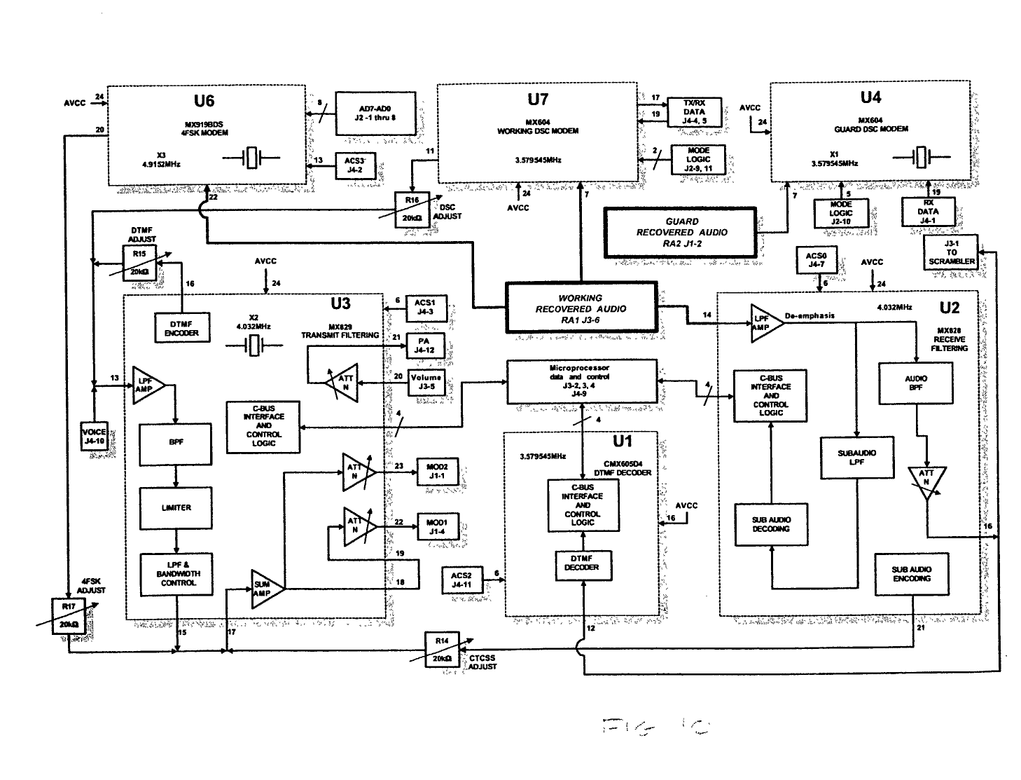

Likewise, the signal from the front end 36 is applied to a second mixer 44. A signal from a second VCO 46 is also applied to the mixer 44. The signal from the second VCO 46 is chosen to be at a frequency which, when combined with the guard channel frequency of interest from the front end 36, will produce a first IF signal of 21.7 MHz on the line 48 as an output from the mixer 44. The signal on the line 48 may then be applied to the guard channel processing circuitry, which includes a narrow band pass filter centered on 21.7 MHz. It will be appreciated that the radio 30 may support the selection of any channel as the guard channel, by electronically varying the output frequency of the VCO 46. This may be done as an internal adjustment, or may done as an internal adjustment or may be selectable by the user by means of any convenient radio controls. An electrical schematic diagram of a preferred embodiment VCO 40, 46 is illustrated in FIG. 9.

It should be noted that in the first embodiment of FIG. 2, the first IF signal for the voice channel is selected at 21.4 Mhz, while the first IF signal for the guard channel is selected at 21.7 Mhz. This is done to minimize cross-talk interference between the voice channel processing circuitry and the guard channel circuitry. Because each circuit is optimized for the particular IF signal frequency, any coupling of the other IF signal frequency into the circuit will have minimal effect because that coupled frequency is outside of the circuits optimized processing frequency.

Another limitation in prior art DSC radios is illustrated in FIG. 3, wherein a graph of channel frequency versus attenuation is illustrated. The attenuation illustrated in FIG. 3 corresponds to the bandpass filtering that is utilized in the prior art front end 14. As can be seen from the graph, the filtering of the prior art front end 14 comprises a bandpass function centered on the fixed guard channel 70. In contrast, both the voice channel 42 and guard channel 48 of the present invention require filtering within the front ends 34, 36 that is adjustable depending upon which particular frequency is chosen as the voice channel and the guard channel. The prior art solution illustrated in FIG. 3 is therefore unacceptable for this application.

FIG. 4 illustrates a preferred embodiment electrical schematic diagram for the front end 34, 36. A filter section 50 provides bandpass filtering wherein the bandpass has an adjustable center frequency. An RF input, such as from the splitter 32, is provided at the input 52. This RF signal is bandpass filtered with a bandpass center frequency determined by a voltage applied to control terminal 54. The filtered RF signal is available at the RF output port 56. As is known in the art, it is common to use an LC (inductance-capacitance) circuit in order to provide filtering of an electrical signal. In the adjustable bandpass filter 50, part of the capacitance used for filtering is a veractive diode (D1, D2). The capacitance of the veractive diode changes with the voltage applied to the input terminal 54.

Because the receiver 30 already includes voltage signals which vary with the voice channel and guard channel frequencies, namely the outputs of VCO 40 and VCO 46 respectively, the values of the components in filter 50 may be chosen such that the VCO voltage may be applied to the front end at input terminal 54 in order to control the center frequency of the bandpass filter 50. This is advantageous in that it simplifies the electrical design of the radio by finding another use for the voltage already being generated by the VCO 40, 46. Alternatively, the control voltage applied to input 54 could be a voltage that is empirically predetermined for the front end 34, 36 and stored digitally (such as in an EEPROM). This stored digital information could be utilized as a look-up table which maps the desired center frequency to the voltage to be input to port 54. The digital information retrieved from the look-up table would then be input into a digital-to-analog converter in order to create the voltage signal to be applied to input 54.

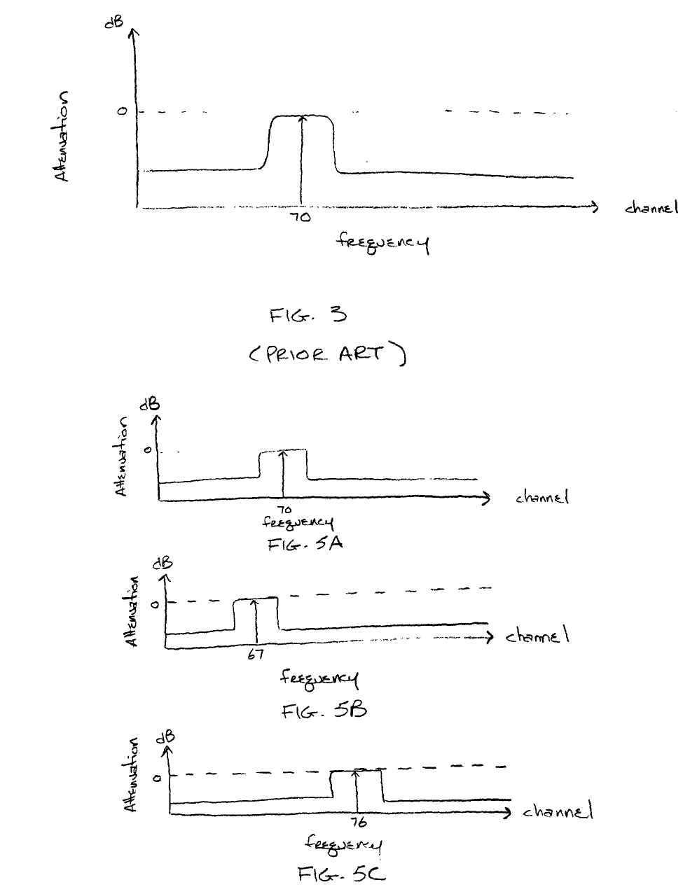

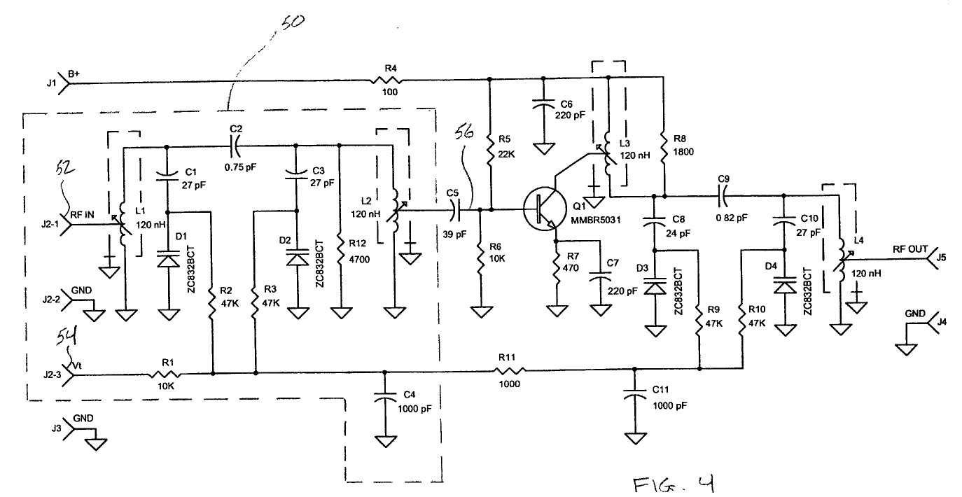

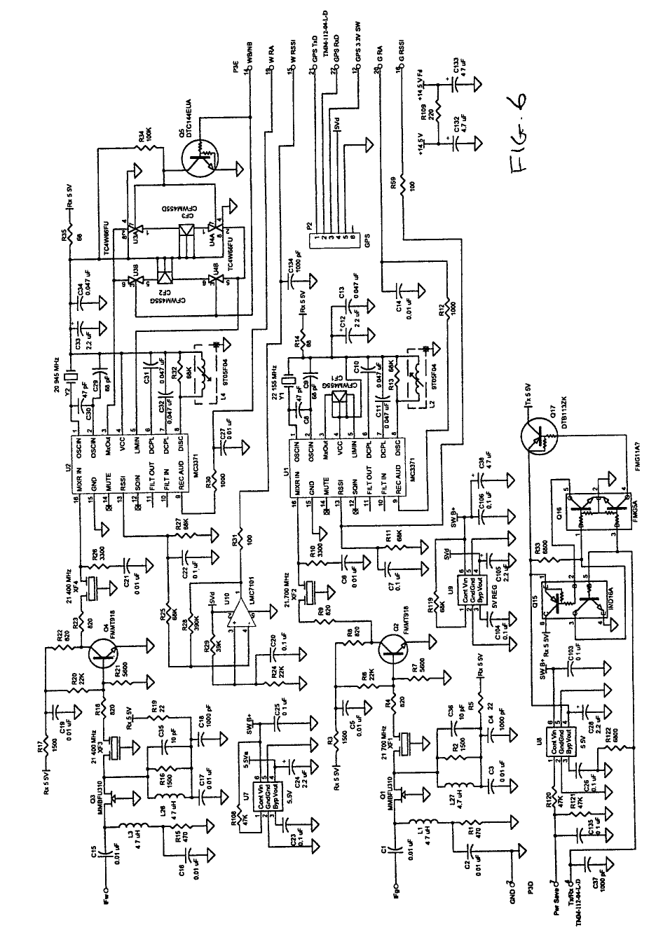

Use of the bandpass filter 50 is illustrated in FIGS. 5a-c. As can be seen from these figures, as the channel frequency (guard channel or voice channel) changes, the center frequency of the bandpass filter 50 changes automatically to track the changing channel frequency. In the preferred embodiment, adjustment of the VCO 40, 46 to change the channel frequency also automatically changes the center frequency of the bandpass filter to match the selected channel frequency because the input control voltage to the VCO 40, 46 is used to control the adjustable bandpass filter 50.

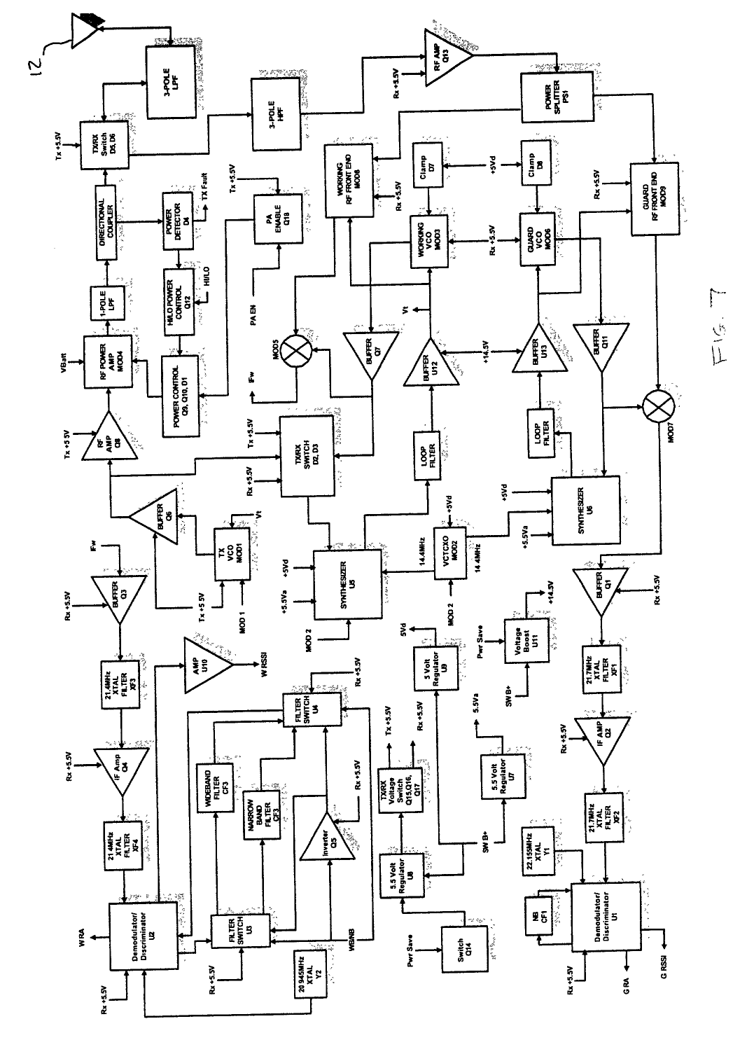

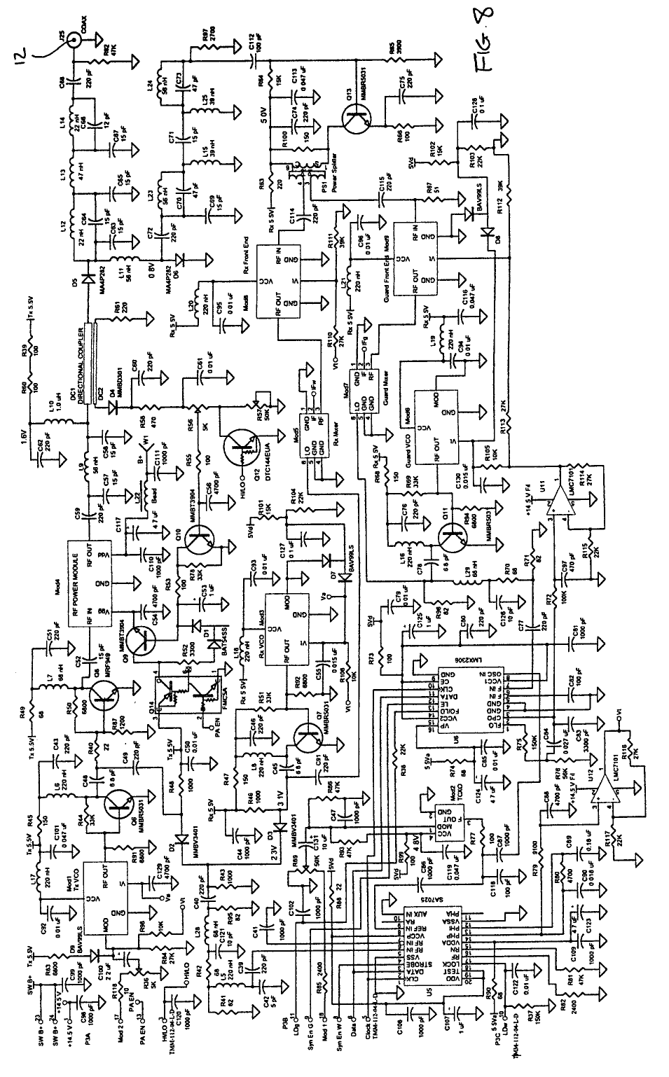

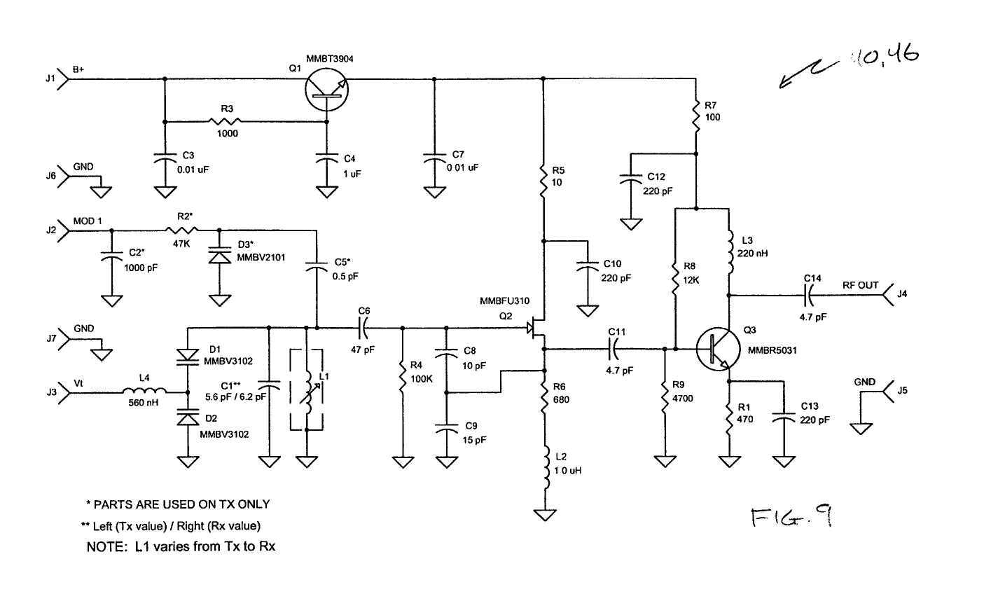

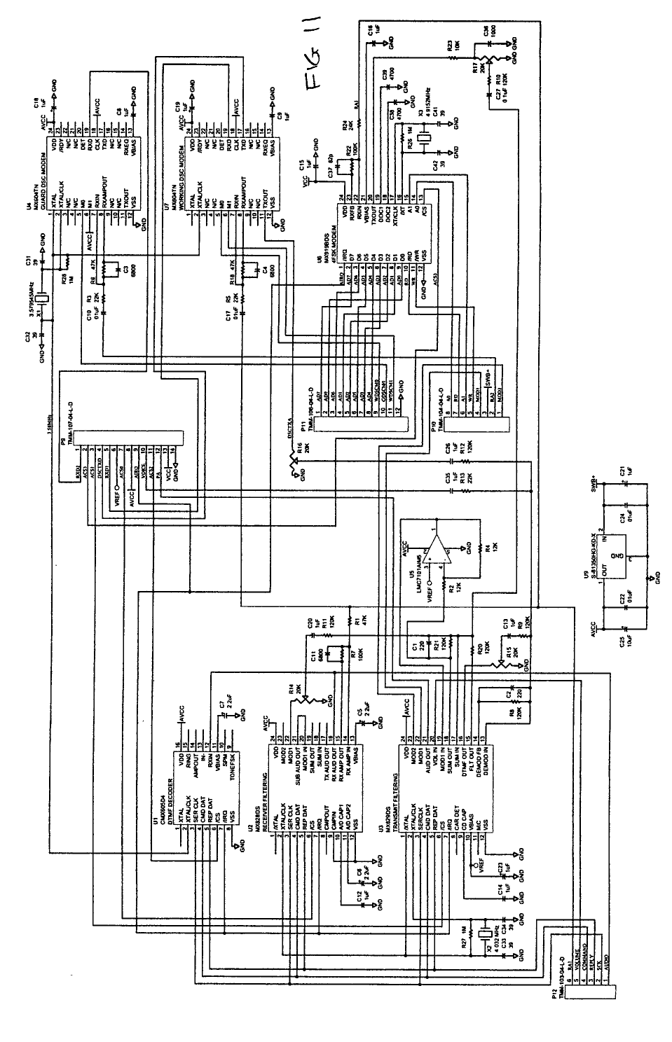

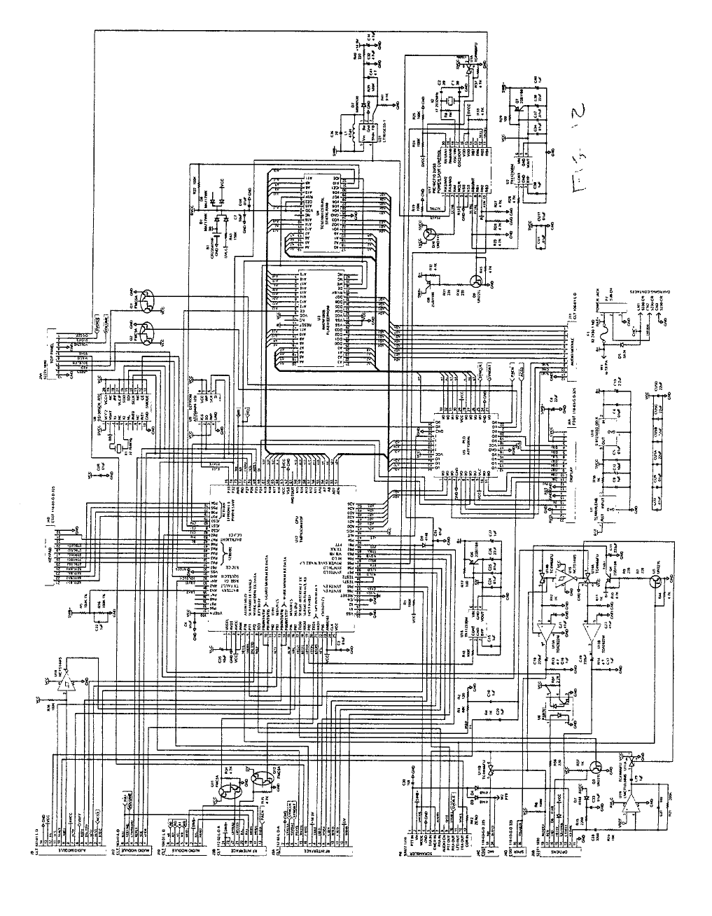

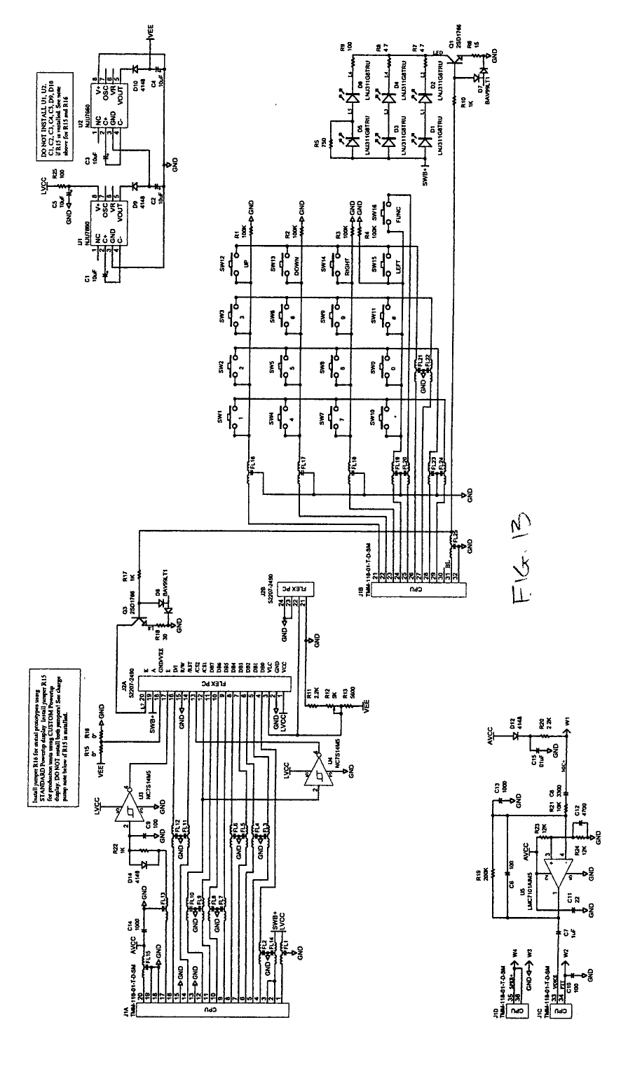

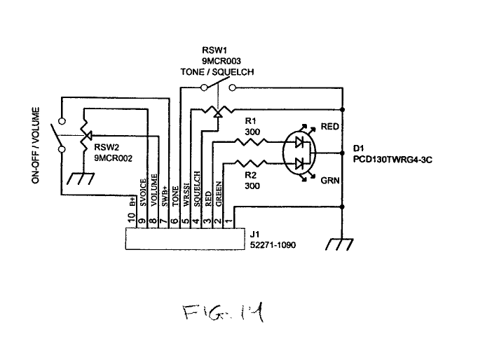

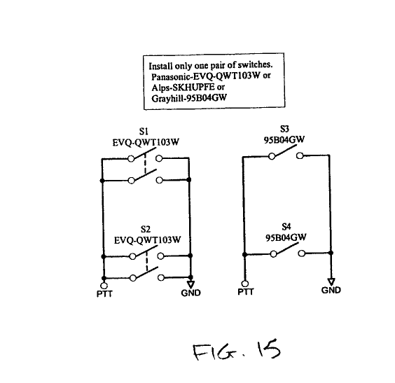

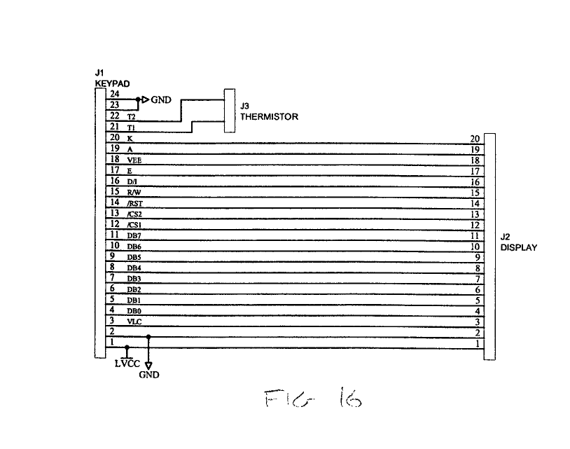

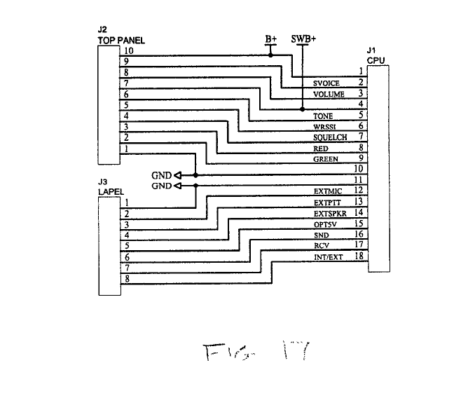

Electrical schematic diagrams for a preferred embodiment of DSC radio of the present invention are illustrated in FIGS. 6-17. FIG. 6 is an electrical schematic diagram of the IF section of a preferred embodiment of the present invention. FIG. 7 is a schematic block diagram and FIG. 8 is an electrical schematic diagram of a main RF section of the preferred embodiment of the present invention. FIG. 9 is an electrical schematic diagram of the VCO 40, 46 of a preferred embodiment of the present invention. FIG. 10 is a schematic block diagram and FIG. 11 is an electrical schematic diagram of an audio module of the preferred embodiment radio of the present invention, illustrating the audio processing circuitry and data modems. FIG. 12 is an electrical schematic diagram of the central processing unit (CPU) and interface for controlling a preferred embodiment radio of the present invention. FIG. 13 is an electrical schematic diagram of a keypad for use in the preferred embodiment radio of the present invention. FIG. 14 is an electrical schematic diagram of the top panel connections for a preferred embodiment radio of the present invention. FIG. 15 is an electrical schematic diagram of the push-to-talk (PTT) switches for use in a preferred embodiment radio of the present invention. FIG. 16 is an electrical schematic diagram of a flex circuit for use with a liquid crystal display (LCD) of the preferred embodiment radio of the present invention. FIG. 17 is an electrical schematic diagram of a flex circuit for use with the top panel of a preferred embodiment radio of the present invention.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed:

1. A hand-held two-way radio comprising:
a VCO operative to modulate the radio signal frequencies of a guard channel such that the guard channel can be changed by changing the output of the VCO.

2. A hand-held two-way radio comprising:
circuitry operative to function according to the digital selective calling international standards; and
a VCO operative to modulate the radio signal frequencies of a guard channel such that the guard channel can be changed by changing the output of the VCO.

3. A hand-held two-way radio comprising:
circuitry operative to send and receive GPS data; and
a VCO operative to modulate the radio signal frequencies of a guard channel such that the guard channel can be changed by changing the output of the VCO.
